(19) United States
(12) Patent Application Publication
(10) Pub. No.: US 2006/0217147 A1
(43) Pub. Date: Sep. 28, 2006

(54) Method and system for system discovery and user selection

(75) Inventors: Ulises Olvera-Hernandez, Kirkland (CA); Alan Gerald Carlton, Mineola, NY (US); Guang Lu, Montreal (CA); Juan Carlos Zuniga, Montreal (CA); Maged Zaki, Pierrefonds (CA); Marian Rudolf, Montreal (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/318,700

(22) Filed: Dec. 27, 2005

Related U.S. Application Data
(60) Provisional application No. 60/645,367, filed on Jan. 18, 2005.

(51) Int. Cl. H04M 1/00

(52) U.S. Cl. 455/552.1; 455/422.1; 370/352; 370/328; 370/338; 455/411

(57) ABSTRACT

The invention includes a method and apparatus for mobility handling across different wireless technologies by efficiently performing alternate network discovery and enabling a mobile station to select the most desirable candidate radio access technology, depending on parameters such as location and network policy settings.

### CROSS REFERENCE TO RELATED APPLICATION

This application claims the benefit of U.S. Provisional Application No. 60/645,367 filed Jan. 18, 2005, which is incorporated by reference as if fully set forth.

### FIELD OF INVENTION

The present invention relates to wireless communications. More specifically, the present invention relates to network discovery and selection in geographical areas wherein more than one cellular and/or IEEE 802 wireless communication system is available.

### BACKGROUND

Wired and wireless communication systems are well known in the art. In recent years, widespread deployment of different types of networks has resulted in geographic areas wherein access to more than one type of network is available. Communication devices have been developed which integrate two or more different network access technologies into a single communication device. For example, there exist communication devices which integrate the ability to communicate via more than one type of wireless standard, such as IEEE 802.X compliant wireless local area network (WLAN) standards, and cellular technologies such as Code Division Multiple Access (CDMA), Global System for Mobile communications (GSM), and General Packet Radio System (GPRS) standards. Communication via each standard is referred to as a communication mode, and devices which can communicate via more than one communication standard are called multi mode devices.

However, existing systems that support integration of two or more network access technologies into one device do not provide inter-working between the different access technologies. In addition, a communication device that supports multi mode functions does not, without more, provide the ability to determine which access technologies are accessible from the device's position, or the ability to assess the desirability of the different access technologies available at the device's position, and choose the best technology available.

In a known approach, a multimode handset can turn multiple radio modems on and scan available networks, frequencies and cells for each radio access technology. However, having two or more radios and modems perform the scanning function consumes a significant amount of power and system resources. Also, this approach does not discover the services available on each available network, and to choose the preferred network.

Thus, there is a need for evaluating and selecting a preferred network from among a plurality of available networks, without the limitations of the prior art.

### SUMMARY

The present invention includes a method and apparatus for facilitating mobility handling across different wireless technologies by efficiently discovering networks available to a wireless transmit/receive unit (WTRU), determining the services available on those networks, and selecting the most appropriate available radio access technology, depending on parameters such as service requirements, available services, location and policy settings.

### BRIEF DESCRIPTION OF THE DRAWINGS

A more detailed understanding of the invention may be had from the following description, given by way of example and to be understood in conjunction with the accompanying drawings, wherein:

FIG. 1 is a diagram of a wireless transmit/receive unit (WTRU) located in a geographical area served by both a WLAN and a cellular network;

FIG. 2 is a block diagram of a dual mode WTRU;

FIG. 3 shows handover of a communication session between a dual mode WTRU and a correspondent node (CoN) from a 3GPP BS to a WLAN BS;

FIG. 4 is a signalling diagram showing network initiated/WTRU controlled system discovery;

FIG. 5 is a flow diagram of a method for discovery of integrated and other services across a plurality of available radio access technologies;

FIG. 5A is a signalling diagram showing system discovery and access of a dual mode WTRU;

FIG. 6 is a flow diagram of a method for signalling used when system discovery fails;

FIGS. 7a and 7b are a flow diagram of a method for signalling used when system authentication fails; and

FIGS. 8a and 8b are a signalling diagram showing 802.x and 3GPP inter-working system access failure.

### DETAILED DESCRIPTION OF THE PREFERRED EMBODIMENTS

The present invention will be described with reference to the drawing figures wherein like numerals represent like elements throughout.

When referred to hereinafter, the term wireless transmit/receive unit (WTRU) includes but is not limited to a user equipment (UE), mobile station (MS), fixed or mobile subscriber unit, pager, or any other type of device capable of operating in a wireless environment. When referred to hereinafter, the term base station (BS) includes but is not limited to a base station, Node-B, site controller, access point (AP) or any other type of interfacing device in a wireless environment.

The present invention includes an apparatus and methods for assisting in mobility handling across different wireless technologies by efficiently performing network discovery, determining services available in discovered networks, and assisting a WTRU in selecting a preferred radio access technology from among a plurality of available radio access technologies, depending on parameters such as service requirements, available services, location and network policy settings.

The present invention enables a multi-mode WTRU, such as a dual-mode WTRU that supports both a cellular network and a Wireless Local Area Network (WLAN), to turn off WLAN scanning while the user is connected to a cellular network, thus conserving WTRU battery power. The cellular network indicates to the dual-mode WTRU when a WLAN is in its vicinity, and that it should start scanning for the WLAN. In a preferred embodiment of the present invention, the cellular network is aware of the geographic locations of the WLANs located within its service area. The cellular network also tracks the position of the WTRU. Various methods can be used to determine the location of the WTRU, such as triangulation, Universal Geographical Area Descriptions or Global Positioning System (GPS) assisted methods. Based on the cellular network's awareness of the locations of the WLANs and the position of the WTRU, the cellular network can determine if there is a WLAN in the vicinity of the WTRU. If so, the cellular network signals to the WTRU that there is a WLAN in its vicinity. The WTRU then begins WLAN discovery procedures. In a preferred embodiment, the cellular network is a 3GPP network and the WLAN is an IEEE 802.X wireless network. This approach extends battery power in the WTRU because it does not scan for a WLAN unless directed to do so by the cellular network, without compromising the effectiveness of WLAN system discovery.

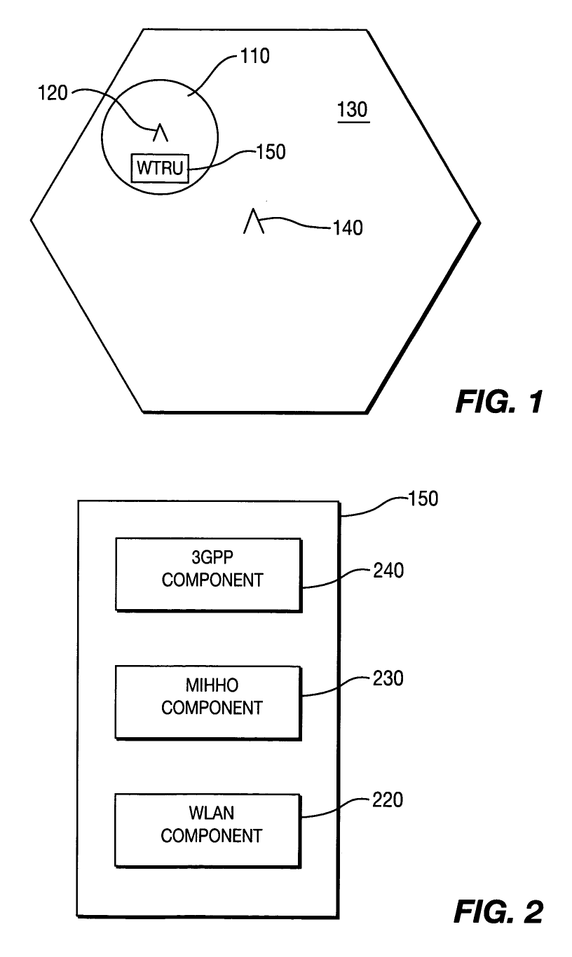

FIG. 1 shows a dual-mode WTRU 150 able to communicate with both a WLAN and a 3GPP network. WTRU 150 has just moved into WLAN service area 110. WLAN communication services are provided within WLAN service area 110 by WLAN BS 120. The WLAN service area 110 is encompassed by 3GPP cell 130. 3GPP communication services are provided within cell 130 by 3GPP BS 140. WTRU 150 is initially conducting communications via a wireless connection with 3GPP BS 140. In accordance with the present invention, when WTRU 150 moves into the WTRU service area 110, WTRU 150 becomes aware that a WLAN is available, as will be discussed hereinafter. WTRU 150 discovers what services are available via WLAN BS 120. WTRU 150 then decides if it should handover its communications from 3GPP BS 140 to WLAN BS 120. If so, it initiates the handover.

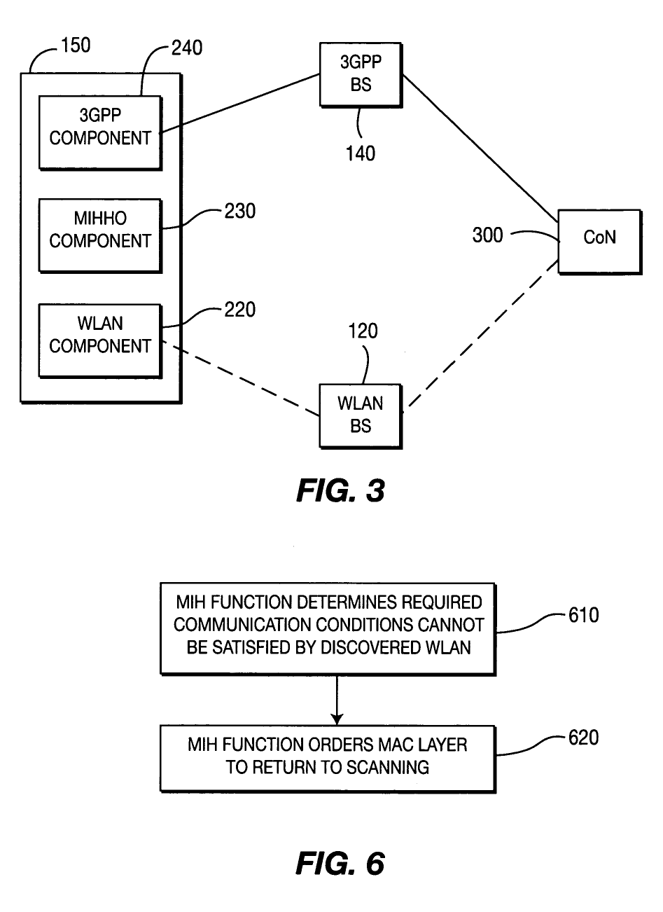

FIG. 2 is a block diagram of the dual-mode WTRU 150. WTRU 150 comprises a 3GPP component 240, able to communicate with 3GPP BS 140 using 3GPP communication standards; a WLAN component 220, able to communicate with WLAN BS 120 using WLAN communication standards; and a media independent handover-handover (MIHHO) component 230, associated with an MIH function. The MIH function facilitates the discovery of available networks, determines which among a plurality of available networks is the preferred network, and facilitates handover from one network to another.

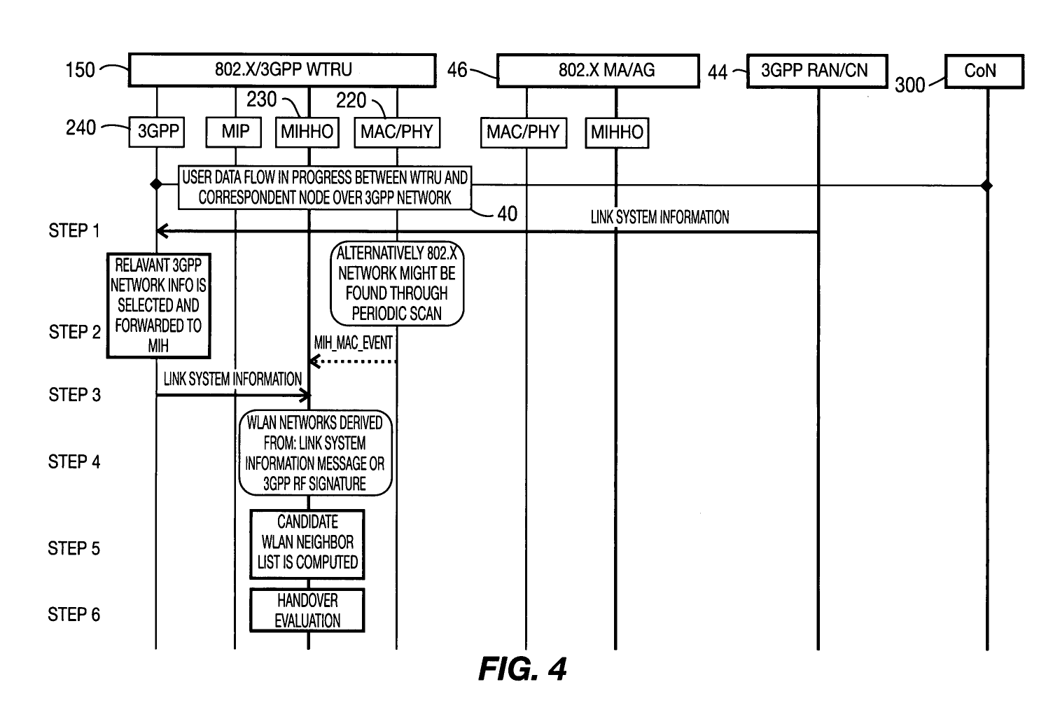

FIG. 3 is a diagram showing handover of an ongoing communication session between dual mode WTRU 150 and a correspondent node (CoN) 300. The communication session is initially conducted via 3GPP component 240 in WTRU 150 and 3GPP BS 140. Additional network components (not shown) are typically located between 3GPP BS 140 and CoN 300. A potential alternate communication path between WTRU 150 and CoN 300 is shown in phantom, comprising WLAN BS 120. Additional network components (not shown) are also typically located between WLAN BS 120 and CoN 300. In a preferred embodiment, the 3GPP network maintains a database of the locations of WLANs whose service areas overlap its own, and tracks the position of WTRU 150. WLAN component 220 in WTRU 150 is kept switched off until the 3GPP network indicates to WTRU 150 the presence of a WLAN in its vicinity. By comparing the position of WTRU 150 with the last known locations of WLANs, the 3GPP network determines when there is a WLAN in the vicinity of WTRU 150. The 3GPP network then sends to WTRU 150 information regarding the available WLAN. The information can be sent in a dedicated message, in a beacon frame, or the like. WTRU 150 reads the system information and determines whether handover to the WLAN is desirable. If so, WTRU 150 initiates handover procedures.

Information used to determine the position of the WTRU 150 can include information derived from triangulation, Universal Geographical Area Descriptions, GPS assisted methods and the like. In addition, the 3GPP system can allocate a specific Temporary Mobile Station Identifier (TMSI) space for routing areas, location areas or service areas supporting WLAN services. Alternatively, the WTRU can use the radio frequency (RF) signature or fingerprinting to determine the availability of a WLAN system. In that case, the WTRU establishes a relationship between the 3GPP radio frequency channel signature of a channel placed at a particular location within the cellular network, and an underlying wireless land network such as a WLAN, which is overlaid by the 3GPP RF channel coverage. This relationship is used to flag the existence of the WLAN network to the WTRU when the WTRU detects the presence of the RF signature. This information is kept in a database within the WTRU, and can be dynamically updated should the relationship be modified.

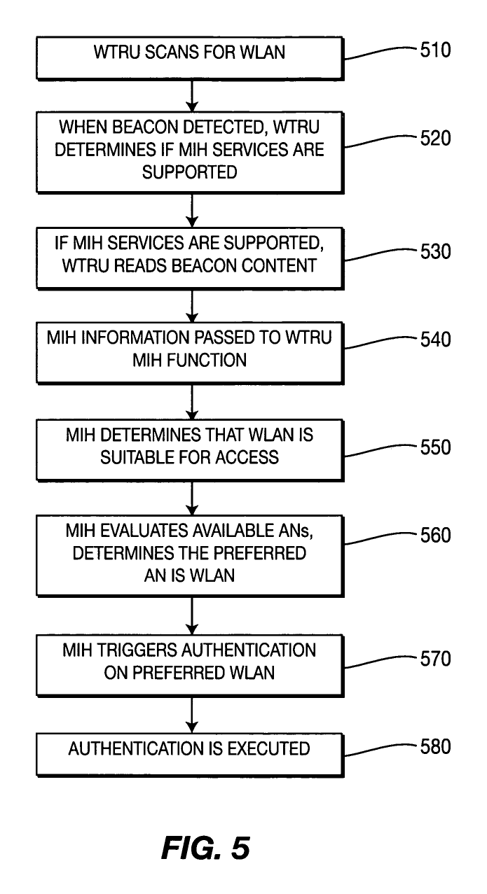

Referring now to FIG. 4, a communication session 40 is shown in progress between a dual mode WTRU 150 and a Correspondent Node (CoN) 300. User data flow is in progress between the WTRU 150 and the CoN 300 over the 3GPP network 44 comprising a 3GPP radio access network (RAN) and a core network (CN). In Step 1, the 3GPP network 44 sends to the WTRU 150 information regarding an available IEEE 802.x compliant WLAN 46, comprising a media access point (MA) and an access gateway (AG). The 3GPP component 240 in the WTRU 150 reads the WLAN system information and determines whether its content can be used for system reselection to the WLAN system 46. In Step 2, the 3GPP component 240 in the WTRU 150 extracts relevant WLAN 46 system information that can be used to determine whether a handover to a WLAN system 46 might be warranted, and forwards this information to the MIHHO component 230 in WTRU 150. The WLAN 46 system information includes information the WTRU 150 needs to determine whether a handover to the WLAN 46 might be warranted, and WTRU 150 forwards this information to its MIHHO component 230. The WTRU 150 then scans for the WLAN 46 in its vicinity. Alternatively, as shown in phantom in Step 2, the WLAN component 220 in WTRU 150 might execute periodic scanning, either continuously or when prompted by system information received from the 3GPP component 240.

In Step 3, relevant WLAN system 46 information extracted from the information sent by the 3GPP system 44 is forwarded to the MIHHO component 230 in a message herein designated a LINK SYSTEM INFORMATION message. Alternatively, as shown in phantom in Step 3, information gained by the WTRU 150 during periodic scanning is forwarded to the MIHHO component 230 in a message herein designated a LINK DETECTED message. If a WLAN is accessible, the WTRU 150 detects the WLAN 46 beacon frames. The beacon frames can be used to identify handover-specific information, such as whether full or partial Media Independent Handover Services are supported (e.g., as indicated through a specific 802.21 flag broadcast on the beacon frame or the like). Beacon frames can also be used to indicate other services available on the WLAN 46. The handover-specific information can be updated either manually or dynamically. As an alternative, the WTRU 150 can attempt to acquire WLAN 46 system information either through a Probe Request/Response message pair or by accessing a data base within the candidate system.

In Step 4, the MIHHO component 230 in the WTRU 150 determines that one or several WLAN networks might be suitable for reselection, based on available information (e.g., explicit indication, RF signature, geographical location, manual or automatic scanning, specific TMSI assignment, or the like). In Step 5, the MIHHO component 230 computes a list of potential candidates for handover selection. In Step 6, the MIHHO component 230 evaluates candidates based on various criteria such as system operator and known WLAN system 46 capabilities such as quality of service (QoS), data transmission speed and the like. The MIHHO component 230 determines the preferred candidate for handover, and triggers WLAN system access by sending a message, herein designated a MIH_SWITCH message, to the media access control (MAC) layer to request handover related actions.

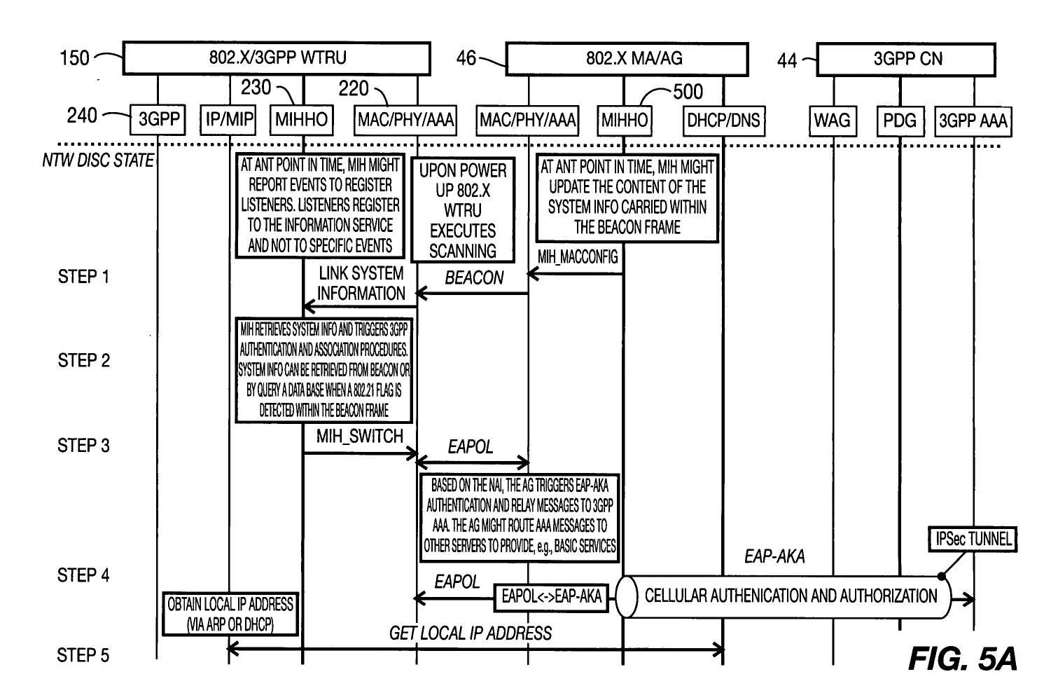

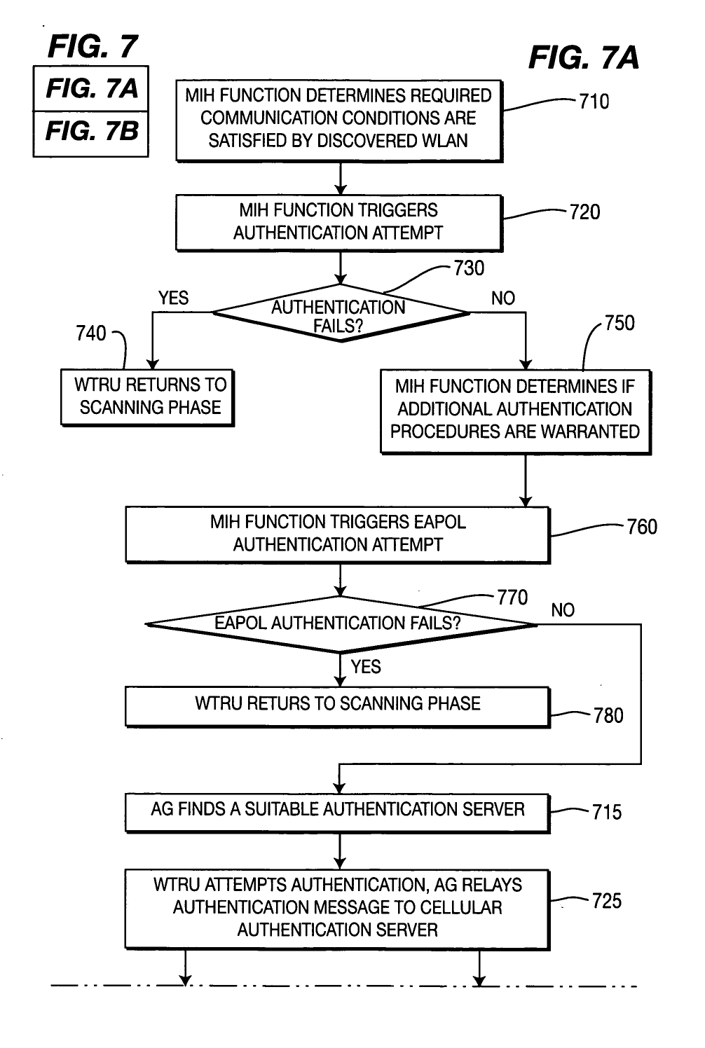

FIG. 5 is a flow diagram showing discovery of integrated and other services across a plurality of available radio access technologies, wherein the MIHHO component 230 in the WTRU 150 receives system information via WLAN beacons. WTRU 150 executes the scanning procedures to find WLAN networks, step 510. Scanning can be either active or passive, and can result in more than one WLAN being discovered. When WLAN beacon frames are detected, WTRU 150 determines whether MIH handover information is supported, step 520. If so, WTRU 150 reads its content, step 530. MIH specific information is set and updated either manually or dynamically by an MIH function residing in the WLAN access network (AN). Any MIH information found within a beacon frame (e.g., system operator identity, W-APN, neighboring maps and system capabilities) is passed to the WTRU's MIHHO component 230 through a message, herein designated a LINK SYSTEM INFORMATION message, step 540. The information is processed and WTRU 150 determines that the WLAN system is a suitable candidate for system access, step 550. The MIH function evaluates this WLAN with other available access networks (ANs), and determines it is the preferred AN, step 560. The MIH function triggers authentication and association with the preferred AN (i.e., the discovered WLAN) through a MIH_SWITCH message to the MAC layer, step 570. WLAN specific authentication and associating procedures are executed on the chosen WLAN system, step 580. Authentication can be via Extensible Authentication Protocol over LAN (EAPOL). It should be noted that in addition to the WTRU scanning for WLAN when prompted by a 3GPP network, the WTRU can scan when powered on.

During WLAN authentication, WTRU 150 provides the WLAN with a Network Access ID (NAI). Based on the NAI, an Access Gateway (AG) can trigger Extensible Authentication Protocol-Authentication and Key Agreement (EAP-AKA) authentication, and relay authentication messages to a 3GPP Authentication, Authorization, and Accounting (AAA) server. The AG can also route AAA messages to other servers to provide services. The AG can use the NAI to determine whether WTRU 150 requires a particular level of service, e.g., basic or premium service. The NAI can also be used to route messages to specific ports that provide specialized services, such as network capabilities available for this particular user or user class.

The AG can also determine the level of service that the WTRU requires based on the NAI that triggered the authentication procedure, or based on the authentication procedure itself. Even if authentication procedures fail for a premium level of service, the AG can determine that the WTRU can receive basic services. If the AG is not able to route the authentication request, it can respond to the WTRU by indicating available AAA servers where an authentication request can be routed. If the WTRU determines that none of them is suitable, it can decide to return to the scanning phase.

The AG can grant access to basic services (e.g., Internet service) or access to a portal that can provide WTRU 150 with further information. The AG can also choose to provide a default Packet Data Gateway (PDG) address. If this is the case the WTRU can decide to connect to the default PDG. This procedure can be automatic, or can be based on configuration parameters within the AG and/or the WTRU. Alternatively, access can be denied.

In accordance with the invention, information on system capabilities is passed by the MAC layer to the MIH function in WTRU 150 using a LINK SYSTEM INFORMATION message. The MIH function may determine that one or more values regarding an available WLAN within the system information parameters do not satisfy a necessary condition for system access. E.g., the system operator is barred, a needed service is not available, or the Quality of Service (QoS) is not adequate. If the MIH function determines that the parameters provided by the information service do not satisfy internal configured requirements, then the MIH function orders the MAC layer to return to the scanning phase using a MIH_SCAN message.

FIG. 5A is a signalling diagram showing system discovery and access by a dual mode WTRU 150. In Step 1, at power up or system reselection the WTRU 150 executes scanning procedures (active or passive) to find a WLAN network. When beacon frames are detected the WTRU 150 first identifies whether MIH information is supported and if so, the WTRU 150 reads its content. MIH specific information is set and updated either manually or dynamically by an access network MIHHO component 500. Any MIH information found within a beacon frame (e.g., system operator identity, W-APN, neighboring maps and system capabilities) is passed to the WTRU's MIHHO component 230 through a LINK SYSTEM INFORMATION message.

In Step 2, the information is processed and the WTRU 150 determines that a WLAN system 46 is a suitable candidate for system access. As a result MIHHO component 230 orders WLAN authentication and association with a message to the MAC layer, herein designated a MIH_SWITCH message.

In Step 3, WLAN specific authentication and associating procedures are executed on the chosen WLAN system. The MIHHO component 230 informs the 3GPP side that handover is imminent.

In Step 4, the WLAN access gateway (AG) MIHHO component 500 triggers WLAN 3GPP authentication and authorization using the EAP-AKA protocol. The WTRU's 3GPP component 240 uses its assigned Network Access ID (NAI) to indicate to the WLAN AG 46 its associated 3GPP AAA server. Successful routing results in the establishment of an IPsec tunnel that carries EAP-AKA messages.

In Step 5, upon successful authentication and authorization the WTRU 150 obtains a local IP address from the local DHCP server.

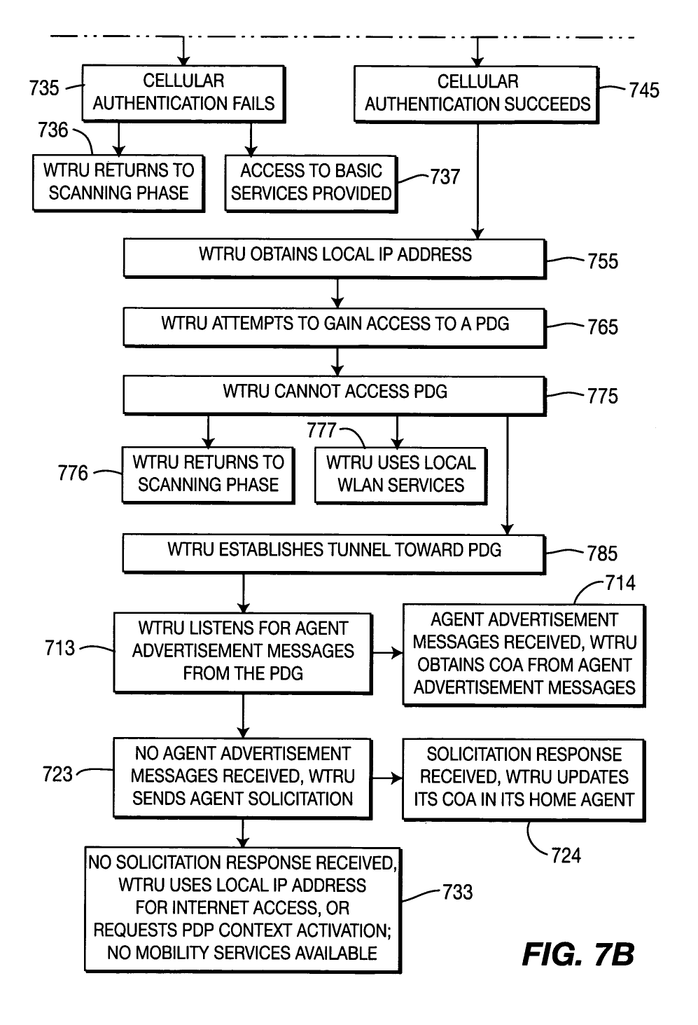

FIG. 6 is a flow diagram showing signalling used when system discovery fails. As described hereinbefore, MIH information found within a beacon frame (e.g., system operator identity, W-APN, neighboring maps and system capabilities) is passed to the WTRU MIHHO component 230 through a LINK SYSTEM INFORMATION message. The MIHHO component 230 determines that one or more values provided within the system information parameters does not satisfy the necessary condition for system access, e.g., the system operator is barred, the QoS is not adequate or there is a better candidate identified within a potential neighboring set provided in the message, step 610. The MIH function orders the MAC layer to return to the scanning phase, step 620.

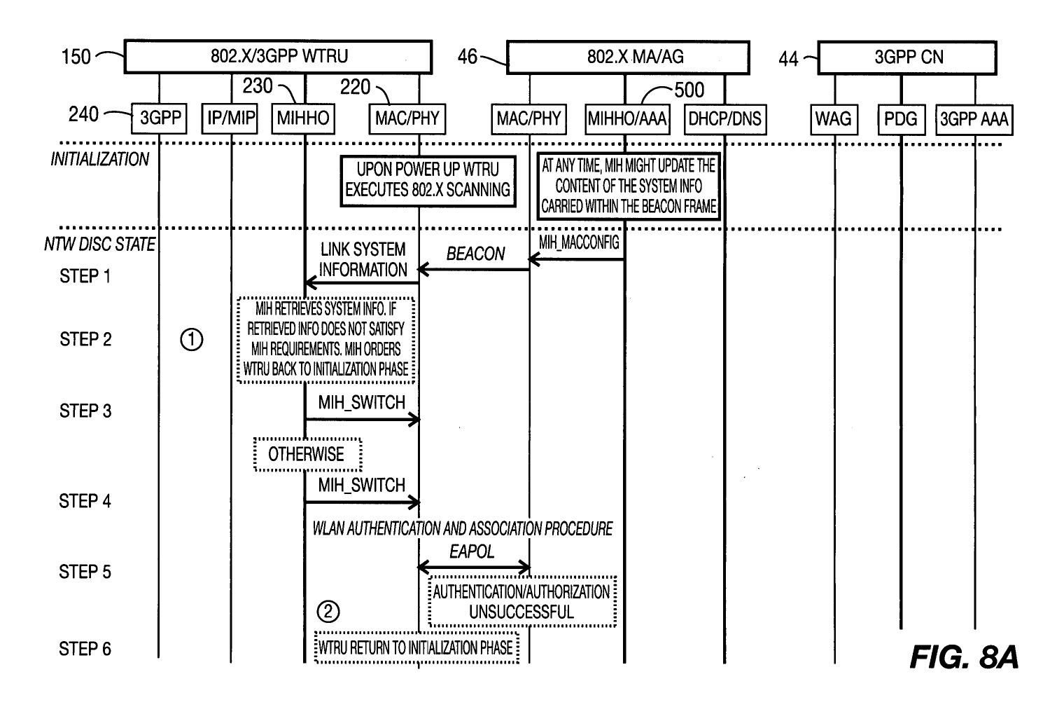

FIGS. 7a-7b are a flow diagram showing signalling used when system authentication fails. Referring to FIG. 7a, the MIH function has determined that communication via a discovered WLAN is desirable, step 710. The WTRU MIH function triggers authentication procedures by sending an MIH_SWITCH message to the MAC layer, step 720. The authentication procedures can include using wired equivalency privacy (WEP). Note that in order to determine whether the user requires further EAP-AKA authentication that will allow access to special services (e.g., 3GPP Internet multimedia service (IMS)), the WTRU can use a specific WEP default key. The AG can use the default key to determine whether to proceed with EAPOL authentication, or whether basic Internet access can be granted.

If authentication fails, then system access is denied, step 730. This can occur, e.g., if WEP authentication fails, or if the NAI provided does not resolve to any 3GPP server. The WTRU can then return to the scanning phase, step 740. Alternatively, if the NAI does not resolve, the AG can direct the WTRU to a local server for further processing, e.g., to provide basic services. The AG MAC can provide the MIH function with information regarding the key that was used for the WEP procedure. The MIH function can then determine, e.g., based on the default key used during WEP authentication, whether further authentication procedures are warranted, step 750. Note that in this context WEP is not considered a secured authentication procedure. Rather, here it is being used to identify users that require further authentication.

If further authentication procedures are warranted, the MIH function triggers a cellular authentication attempt, e.g., using EAPOL authentication procedures, step 760. The AAA AG component can act as an authenticator between the WTRU supplicant and the AAA authentication server, e.g., using an IPsec tunnel. The AG uses the NAI provided during the initial message exchange to determine the AAA server that can execute the authentication procedure. If the AG is not able to route the authentication request, the EAPOL cellular authentication attempt fails, step 770. The AG can respond by indicating the available AAA servers where the request can be routed. If the WTRU determines that none of them is suitable, it can decide to return the scanning phase, step 780. If the AG can find a suitable authentication server using the NAI provided by the WTRU, the WTRU can attempt authentication to that server, step 715. In that case, the AG can relay authentication messages between the WTRU and the authentication server, step 725.

Referring to FIG. 7b, the WTRU can then fail the cellular authentication procedure, step 735. If so, all access can be denied, and the WTRU can then return to the scanning phase, step 736. Or, only access to special services, such as 3GPP services, can be denied, and access to basic services can be provided, step 737.

However, the cellular AAA server can successfully authenticate the WTRU, step 745. If so, the WTRU proceeds to obtain a local IP address, e.g. via dynamic host control protocol (DHCP) or address resolution protocol (ARP), step 755. Using a WLAN access point name (W-APN) network ID and operator ID, the WTRU constructs a Fully Qualified Domain Name (FQDN). The WTRU then requests IP address resolution to gain access to a packet data gateway (PDG), step 765. The WTRU attempts to get a PDG address based on the FQDN, e.g., a W-APN or public land mobile network (PLMN) ID. If the domain name server (DNS) does not resolve the FQDN to any PDG IP address, the WTRU cannot access a PDG within the existing WLAN network, step 775. The WTRU can then choose to return the scanning phase, step 776, or to settle for only local WLAN services, step 777.

However, if the DNS returns a valid PDG IP address, the WTRU establishes a tunnel toward the PDG, e.g., a L2TP tunnel, step 785. The WTRU then listens for Agent Advertisement messages from the PDG, step 713. If no Agent Advertisement messages are received, the WTRU sends an Agent Solicitation, step 723. However, if Agent Advertisement messages are received from the PDG, then the WTRU is able to obtain its care of address (COA) directly from these messages without a need to specifically request it via an Agent Solicitation message, step 714.

If no response to the Agent Solicitation is received, e.g., if MIP is not supported, the WTRU can use its local IP address for transparent access to the Internet for basic ISP services, or can request activation of a packet data protocol (PDP) context, step 733. WTRU-PDG tunnel IP traffic can be routed directly from the WTRU to the Internet via the PDG tunnel. This scenario does not provide seamless mobility beyond the PDG domain. However, if a response to an Agent Solicitation is received then the WTRU is able to update its COA in its Home Agent, step 724. Any message intended for this WTRU will be re-directed by the Home Agent to the new COA.

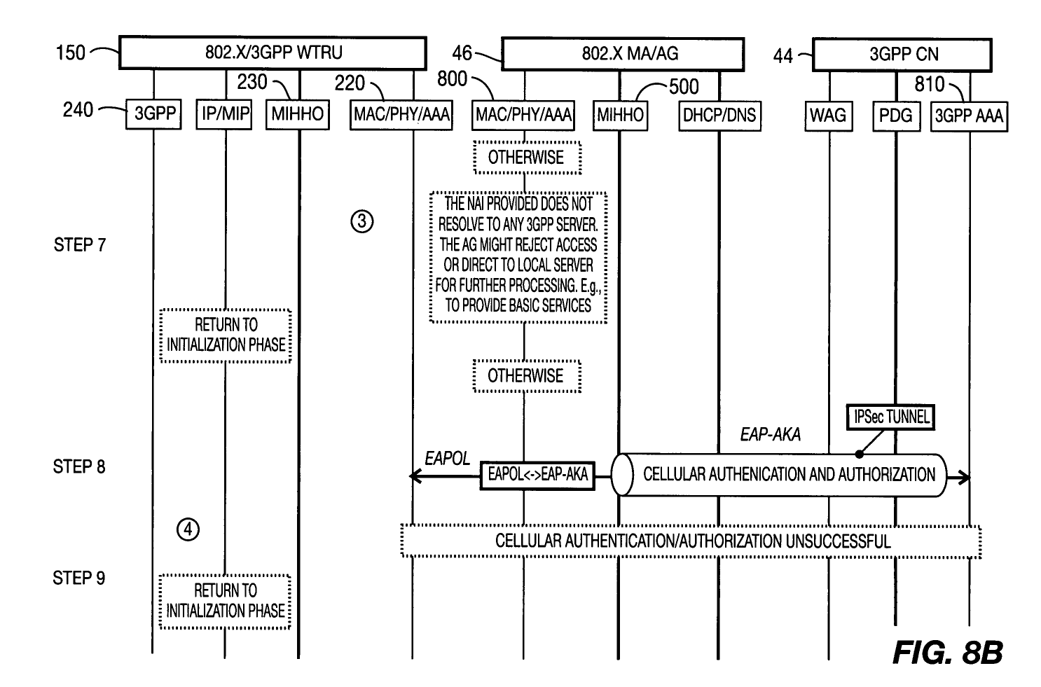

FIGS. 8A and 8B comprise a signalling diagram showing 802.x and 3GPP inter-working system access failure. In Step 1, at power up or system reselection the WTRU 150 executes the scanning procedures (active or passive) to find a WLAN network. When beacon frames are detected the WTRU 150 first identifies whether MIH information is supported and if so, the WTRU 150 reads its content. MIH specific information is set and updated either manually (through a management system) or dynamically by the AG MIHHO component 500.

In Step 2, any MIH information found within a beacon frame (e.g., system operator identity, W-APN, neighboring maps and system capabilities) is passed to the WTRU's MIHHO component 230 through a LINK SYSTEM INFORMATION message. The MIHHO component 230 determines that one or more values provided within the system information parameters does not satisfy the necessary condition for system access. For example, the system operator may be barred, the QoS is not adequate or there is a better candidate identified within a potential neighboring set provided in the message. This scenario represents the first failure case. This is depicted in FIG. 8A with an encircled “1”.

In Step 3, if the MIHHO component 230 determines that the parameters provided by the information service do not satisfy internal configured requirements, then the MIHHO component 230 orders the MAC layer to return to the scanning phase with an MIH_SCAN message.

In Step 4, if instead the MIHHO component 230 determines that internal configured requirements are satisfied, the MIHHO component 230 triggers WEP authentication with an MIH_SWITCH message toward its MAC layer. Note that in order to determine whether the user requires further EAP-AKA authentication that will allow access to special services (e.g., 3GPP IMS), the WTRU 150 might use a specific WEP default key. The AG might use a specific default key to determine whether it shall proceed further with EAPOL authentication or basic Internet access can be granted.

In Step 5, the WTRU 150 is authenticated according to current 802.11 WEP procedures.

In Step 6, if WEP authentication fails, system access is denied. The WTRU 150 can then return to the scanning phase. This scenario represents the second failure case, depicted in FIG. 8A with an encircled “2”.

In Step 7, instead of the WTRU 150 returning to the scanning phase if WEP authentication fails, the AG MAC 800 can provide the AG MIHHO component 500 with information regarding the key that was used for the WEP procedure. This allows the MIH function to determine, e.g., based on the default key used during WEP authentication, whether further authentication procedures are warranted, e.g., based on the NAI provided. Note that WEP is not considered a secured authentication procedure. It this context it used primarily to identify specific users that require further authentication. If the NAI provided does not resolve to any 3GPP server, the AG 46 might reject access or direct the WTRU 150 to a local server for further processing, e.g., to provide basic services. This is depicted in FIG. 8A with an encircled “3”.

In Step 8, AG MIHHO component 500 uses a message, herein designated a MIH_SYSCAP message, to trigger EAPOL authentication procedures.

In Step 9, the AG 46 executes EAPOL procedures. The AG AAA component 800 will act as an authenticator between the supplicant (WTRU 150) and the authentication server 810 (AAA). The AG 46 uses the NAI provided during the initial message exchange in order to determine the AAA server 810 that shall execute the authentication procedure. If the AG 46 is not able to route the authentication request, it responds indicating the available AAA servers where the request can be routed. If the WTRU 150 determines that none of them is suitable, it might decide to return the scanning phase. This is depicted in FIG. 8B with an encircled “4”.

Although the features and elements of the present invention are described in the preferred embodiments in particular combinations, each feature or element can be used alone (without the other features and elements of the preferred embodiments) or in various combinations with or without other features and elements of the present invention.

What is claimed is:

1. A method for a multi-mode wireless transmit/receive unit (WTRU) in communication with a cellular network to become aware of and establish a communicative coupling with an accessible wireless local area network (WLAN), comprising:
providing a communicative coupling between the WTRU and the cellular communication system;
providing the cellular system with the locations of WLANs within its service area;
tracking the position of the WTRU;
comparing the position of the WTRU with the known locations of the WLANs;
detecting when the WTRU is in the vicinity of a WLAN such that the WTRU can establish a communicative coupling with the WLAN;
notifying the WTRU that a WLAN is in its vicinity;
determining if the WTRU should establish a communicative coupling with the WLAN; and
if affirmative, the WTRU establishing a communicative coupling with the WLAN.

2. The method of claim 1 wherein the cellular network is one of a Code Division Multiple Access (CDMA) system, a Global System for Mobile communications (GMS) system, a General Packet Radio System (GPRS) and a 3GPP compliant system, and the WLAN is an IEEE 802.X compliant WLAN.

3. The method of claim 1 wherein the step of providing the cellular system with the locations of WLANs comprises maintaining in a database in the cellular communication system the locations of WLANs with service areas that overlap the service area of the cellular communication system.

4. The method of claim 1 wherein the tracking step comprises using information derived from at least one of triangulation, Universal Geographical Area Descriptions, Global Position Systems, Temporary Mobile Station Identifier (TMSI) spaces, and radio frequency (RF) signatures.

5. The method of claim 1 wherein the notifying step comprises the cellular networking sending to the WTRU information regarding the WLAN in a dedicated message or a beacon frame.

6. The method of claim 5 wherein the information regarding the WLAN comprises an indication of at least one of a level of handover functionality supported and services that are available on the WLAN.

7. The method of claim 6 wherein information from which the indication is generated is updated manually or dynamically.

8. The method of claim 1 wherein after the notifying step the WTRU acquires WLAN system information through a Probe Request/Response message pair with the WLAN or by accessing a data base within the WLAN.

9. The method of claim 1 wherein the step of determining if the WTRU should establish a communicative coupling with the WLAN is performed by the WTRU or by the cellular network.

10. The method of claim 1 wherein the step of establishing a communicative coupling with the WLAN comprises the WTRU scanning for the WLAN.

11. The method of claim 10 wherein the scanning is active or passive.

12. The method of claim 10 wherein the scanning is performed periodically until the WTRU detects the WLAN.

13. The method of claim 1 wherein a plurality of available WLANs are detected in the vicinity of the WTRU with which the WTRU can establish a communicative coupling, the WTRU computes a list of the available WLANs, and the determining step comprises determining a preferred WLAN with which to establish a communicative coupling.

14. The method of claim 13 wherein the WTRU determines the preferred WLAN by evaluating WLAN information comprising at least one of system operator, quality of service (QoS) and data transmission speed.

15. A multi-mode wireless transmit/receive unit (WTRU) able to receive and process information regarding at least one wireless local area network WLAN in its vicinity, determine which of a plurality of possible communication couplings is a preferred coupling, and establish the preferred communication coupling, comprising:
a cellular component for communicating via a communicative coupling with a cellular network;
a WLAN component for communicating via a communicative coupling with a WLAN; and
a media independent handover-handover (MIHHO) component for facilitating the discovery of available networks, determining which of a plurality of possible communication couplings is a preferred coupling, and facilitating establishing the preferred communication coupling.

16. The WTRU of claim 16 wherein the cellular network is one of a Code Division Multiple Access (CDMA) system, a Global System for Mobile communications (GMS) system, a General Packet Radio System (GPRS) and a 3GPP compliant system, and the WLAN is an IEEE 802.X compliant WLAN.

17. The WTRU of claim 15 further comprising a Global Positioning System (GPS) receiver that provides to the cellular network information regarding the position of the WTRU.

18. The WTRU of claim 15 configured to acquire information regarding the WLAN through at least one of messages received from the cellular network containing information regarding the WLAN, a Probe Request/Response message pair with the WLAN, and accessing a data base within the WLAN, and to extract the WLAN information therefrom.

19. The WTRU of claim 18 wherein the MIHHO component is configured to use the WLAN information to determine if the WTRU should establish a communicative coupling with the WLAN.

20. The WTRU of claim 15 wherein establishing the preferred communication coupling is begun by scanning for the WLAN.

21. The WTRU of claim 20 wherein the scanning is active or passive.

22. The WTRU of claim 20 wherein the scanning is performed periodically until the WTRU detects the WLAN.

23. The WTRU of claim 20 wherein a plurality of available WLANs are detected in the vicinity of the WTRU with which the WTRU can establish a communicative coupling, and the MIHHO component is configured to determine a preferred WLAN with which to establish a communicative coupling.

24. The WTRU of claim 23 wherein the MIHHO component is configured to determine the preferred WLAN by evaluating WLAN information comprising at least one of system operator, quality of service (QoS) and data transmission speed.

25. A wireless local area network (WLAN) access point comprising:
a media independent handover (MIH) device configured to transmit MIH information to facilitate a handover between the WLAN and a cellular network of a wireless transmit/receive unit (WTRU), the MIH information comprising for each of a plurality of identified networks a network identifier, a network location, a system operator identifier, a system capability, a quality of service (QoS) parameter, and a radio access type.

26. The WLAN access point of claim 25, wherein the MIH information further comprises a data transmission speed of each network.

27. The WLAN access point of claim 25, wherein the MIH information further comprises a network policy setting of each network.

28. The WLAN access point of claim 25, wherein the MIH information is sent over a beacon frame.

29. The WLAN access point of claim 25, wherein the MIH information is sent over a dedicated frame.

30. The WLAN access point of claim 25, wherein the MIH information is sent over a broadcast channel.

31. The WLAN access point of claim 25, wherein some of the MIH information is retrieved from a database on a network and is not transmitted as broadcast information.

32. A wireless transmit/receive unit (WTRU) comprising:
a media independent handover (MIH) device configured to receive MIH information to facilitate a handover of the WTRU between a WLAN and a cellular network, the MIH information comprising for each of a plurality of identified networks a network identifier, a network location, a system operator identifier, a system capability, a quality of service (QoS) parameter, and a radio access type.

33. The WTRU of claim 32, wherein the MIH information further comprises a data transmission speed of each network.

34. The WTRU of claim 32, wherein the MIH information further comprises a network policy setting of each network.

35. The WTRU of claim 32, wherein the MIH information is received over a beacon frame.

36. The WTRU of claim 32, wherein the MIH information is received over a dedicated frame.

37. The WTRU of claim 32, wherein the MIH information is received over a broadcast channel.

38. The WTRU of claim 32, wherein some of the MIH information is retrieved from a database on a network and is not transmitted as broadcast information.

39. A network access point comprising:
a media independent handover (MIH) device configured to transmit MIH information to facilitate a handover between the network and a cellular network of a wireless transmit/receive unit (WTRU), the MIH information comprising for each of a plurality of identified networks a network identifier, a network location, a system operator identifier, a system capability, a quality of service (QoS) parameter, and a radio access type.

40. The network access point of claim 39, wherein the MIH information comprises a data transmission speed of each network.

41. The network access point of claim 39, wherein the MIH information comprises a network policy setting of each network.

42. The network access point of claim 39, wherein the MIH information is sent over a beacon frame.

43. The network access point of claim 39, wherein the MIH information is sent over a dedicated frame.

44. The network access point of claim 39, wherein the MIH information is sent over a broadcast channel.

45. The network access point of claim 39, wherein some of the MIH information is retrieved from a database on a network and is not transmitted as broadcast information.

46. A method for use by a wireless transmit/receive unit (WTRU) comprising:
providing a communicative coupling between the WTRU and a first network using a first access technology;
receiving MIH information to facilitate a handover of the WTRU between the first network and a preferred network using a second access technology, the MIH information comprising for each of a plurality of identified networks a network identifier, a network location, a system operator identifier, a system capability, a quality of service (QoS) parameter, and a radio access type;
evaluating the MIH information to determined the preferred network; and
initiating a handover of the WTRU to the preferred network.

47. The method of claim 46, wherein the MIH information further comprises a data transmission speed of each network.

48. The method of claim 46, wherein the MIH information further comprises a network policy setting of each network.

49. The method of claim 46, wherein the MIH information is received over a beacon frame.

50. The method of claim 46, wherein the MIH information is received over a dedicated frame.

51. The method of claim 46, wherein the MIH information is received over a broadcast channel.

52. The method of claim 46, wherein some of the MIH information is retrieved from a database on a network and is not transmitted as broadcast information.
